(19) United States
(12) Patent Application Publication
(10) Pub. No.: US 2015/0139657 A1
(43) Pub. Date: May 21, 2015

(54) High data rate transmission

(71) Applicant: Erez Moshe Yahalomi, Ramat Hasharon (IL)

(72) Inventor: Erez Moshe Yahalomi, Ramat Hasharon (IL)

(21) Appl. No.: 14/401,624

(22) PCT Filed: May 20, 2013
(86) PCT No.: PCT/IL13/50427

§ 371 Date: Nov. 17, 2014

Related U.S. Application Data
(60) Provisional application No. 61/649,304, filed on May 20, 2012.

(51) Int. Cl. H04L 27/00; H04B 10/516; H04B 10/2575

(52) U.S. Cl. CPC H04L 27/0008; H04B 10/2575; H04B 10/5161
USPC 398/115

(57) ABSTRACT

A systems and methods for high data bit rate transmissions. In wireless or wired data transmissions. This method applied mostly to: cellular communication, optical communication and data transfer by cupper wires. This method applied as well to: satellite communication, Wi Fi, storage systems data transmission. The method is realized by software or hardware or combined.

### BACKGROUND OF THE INVENTION

Known transmission methods of communication signals use various modulation methods in order to create a signal carrying data. Some of these modulation methods include Phase-Shift Keying (PSK), Amplitude-Shift Keying (ASK) or Frequency-Shift Keying (FSK). Derivative methods of PSK include Differential Phase-Shift Keying (DPSK), Coherent Phase-Shift Keying (CPSK), Binary Phase-Shift Keying or Phase Reversal Keying (BPSK or PRK), Quadrature Phase-Shift Keying (QPSK), and more.

The simplicity of PSK makes it popular for use in existing technologies. Wireless Local Area Network (LAN) standards use a variety of different PSK methods depending on the data-rate required. For example, wireless LAN uses Differential Binary Phase-Shift Keying (DBPSK) at the basic-rate of 1 Mb/s, Differential Quadrature Phase-Shift Keying (DQPSK) to provide the extended rate of 2 Mb/s, QPSK for reaching 5.5 Mb/s to 11 Mb/s, coupled with complementary code keying. Other modes use Orthogonal Frequency-Division Multiplexing (OFDM) modulation, where each sub-carrier is modulated by BPSK, OFDM with QPSK, or OFDM with forms of quadrature amplitude modulation.

BPSK is usually appropriate for low-cost passive transmitters, and is usually used in RFID standards, for example which have been adopted for biometric passports, credit cards and many other applications.

Reference is now made to FIG. 1, which is a schematic timing diagram of QPSK. BPSK is a basic function producing a signal out of a cosine wave. An example to a produced BPSK signal may look as the in-phase signal component denoted by I in FIG. 1. The data-stream represented by the signal is shown above the signal by 1 or 0. QPSK uses four points on the constellation diagram, equi-spaced around a circle. With four phases, QPSK can encode two signals I and Q, per one symbol (as shown in FIG. 1). The in-phase signal component is denoted by I and the quadrature signal component is denoted by Q. The resulted combined signal encodes the four possible combinations 11, 00, 01 and 10 of the two signals I and Q as shown in FIG. 1. Therefore, QPSK may be used either to double the data rate compared to a BPSK system while maintaining the bandwidth of the signal or to maintain the data-rate of BPSK but half the bandwidth needed.

The QPSK modulated signal is shown in FIG. 1. The two carrier waves are a cosine wave and a sine wave. Here, the odd-numbered signals have been assigned to the in-phase signal component I and the even-numbered signals to the quadrature signal component Q. The total signal—the sum of the two components—is shown at the bottom. Jumps in phase can be seen as the PSK changes the phase on each component at the start of each signal-period. The topmost waveform alone matches a BPSK signal. The binary data stream of the combined signal is shown beneath the time axis. The binary data that is conveyed by this waveform is: 1 1 0 0 0 1 1 0. The odd signals that contribute to the in-phase component are 1 0 0 1. The even signals that contribute to the quadrature-phase component are 1 0 1 0.

Offset Quadrature Phase-Shift Keying (OQPSK) is a variant of phase-shift keying modulation using 4 different values of the phase to transmit In OQPSK, the timing of the odd and even signals is offset by one signal-period, or half a symbol-period, so that the in-phase and quadrature components will never change at the same time. This will limit the phase-shift to no more than 90° at a time. This yields much lower amplitude fluctuations than non-offset QPSK and is sometimes preferred in practice.

Alternatively, the phase between two successive received symbols may be compared and used to determine what the data must have been. When differential encoding is used in this manner, the scheme is known as differential phase-shift keying (DPSK).

In optical communications, the data can be modulated onto the phase of a laser in a differential way. The modulation is performed by a laser which emits a continuous wave, and a Mach-Zehnder modulator which receives electrical binary data. For the case of BPSK for example, the laser transmits the field unchanged for binary ‘1’, and with reverse polarity for ‘0’. The demodulator consists of a delay line interferometer which delays one signal, so two signals can be compared at one time. In further processing, a photo diode is used to transform the optical field into an electric current, so the information is changed back into its original state.

Amplitude-Shift Keying (ASK) is a form of modulation that represents digital data as variations in the amplitude of a carrier wave. In ASK, the probability to make an error increases if the number of levels amplitude or the power of noise becomes greater.

Polarization mode dispersion (PMD) is a form of modal dispersion where two different polarizations of light in a waveguide, which normally travel at the same speed, travel at different speeds due to random imperfections and asymmetries, causing random spreading of optical pulses. In a realistic fiber there are random imperfections that break the circular symmetry, causing the two polarizations to propagate with different speeds. In this case, the two polarization components of a signal will slowly separate, e.g. causing pulses to spread and overlap. Unless it is compensated, which is difficult, this ultimately limits the rate at which data can be transmitted over a fiber. A PMD compensation system uses a polarization controller to compensate for PMD in fibers. Because the PMD effects are random and time-dependent, this requires an active device that responds to feedback over time. The pulse spreading effects correspond to a random walk, and thus have a mean polarization-dependent time-differential Δτ (also called the Differential Group Delay, or DGD) proportional to the square root of propagation distance L:

Δτ=D_{PMD}\sqrt{L}

DPMD is the PMD parameter of the fiber, typically measured in ps/√km, a measure of the strength and frequency of the imperfections.

Group velocity dispersion (GVD) causes a short pulse of light to spread in time as a result of different frequency components of the pulse travelling at different velocities. GVD is often quantified as the group delay dispersion parameter. This makes dispersion management extremely important in optical communications systems based on optical fiber, since if dispersion is too high, a group of pulses representing a signal-stream will spread in time and merge together, rendering the signal-stream unintelligible. This limits the length of fiber that a signal can be sent down without regeneration.

### SUMMARY

According to some embodiments of the present invention, a system for high data rate transmission is provided herein. The system may include a data signals transmitter having a data signal generator configured to produce a data transmission by generating two or more successive transmitted signals having different types of signals; and a receiver to configured to receive the transmitted signals and to identify the signals according to the different types of signals, wherein the different types of signals are based on a specified order according to which both the transmitter and the receiver are synchronized.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a QPSK modulated signal;

FIG. 2 is a schematic illustration of a data communication system for high-rate data transmission according to embodiments of the present invention;

FIG. 12 is a schematic representation of a optical communication system, which transmit and receive signals wherein two successive signals have different modulation types and the signals propagation media is optical fiber.

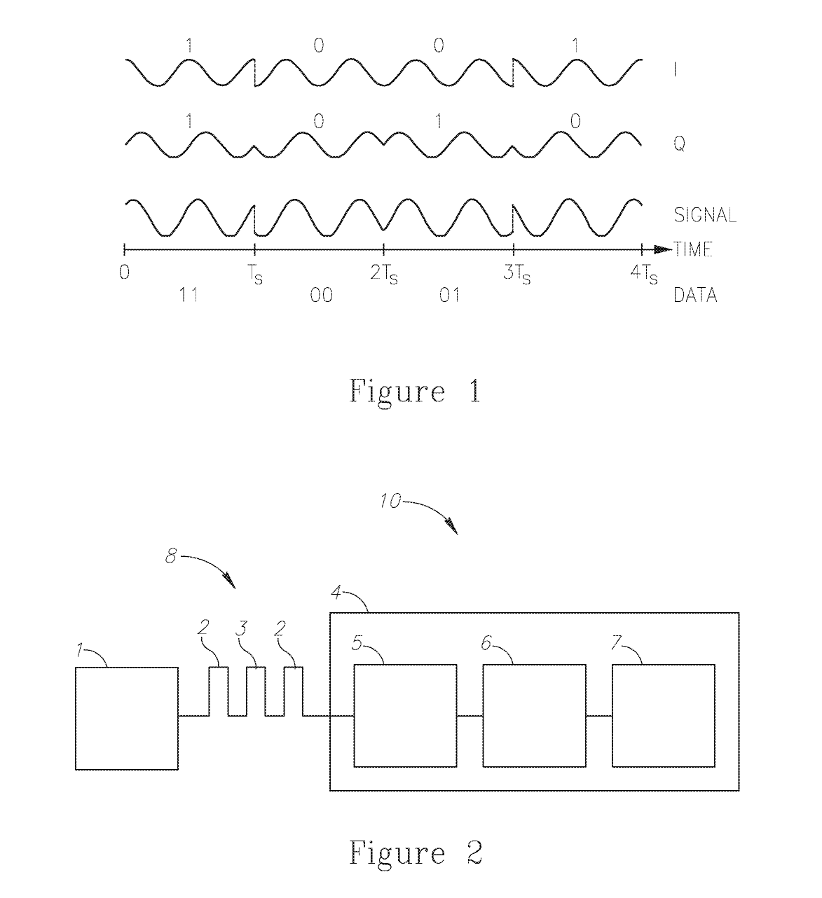

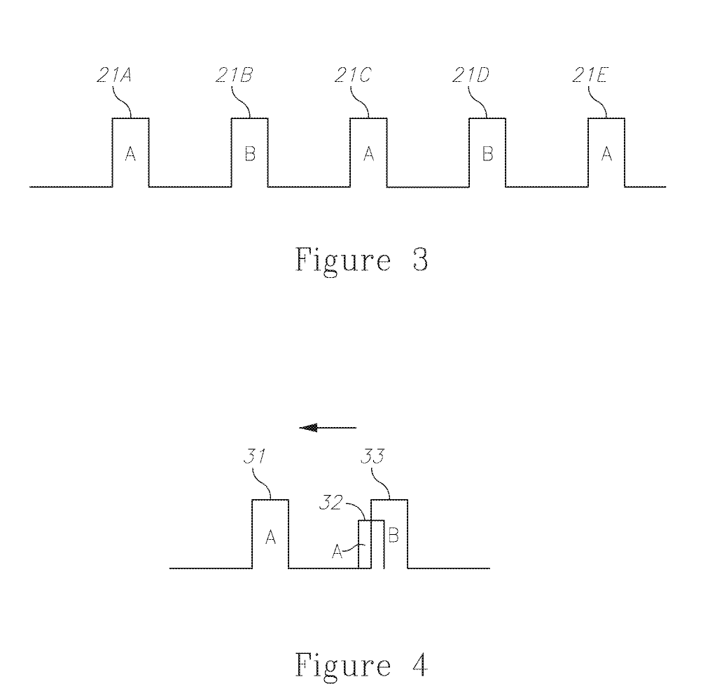

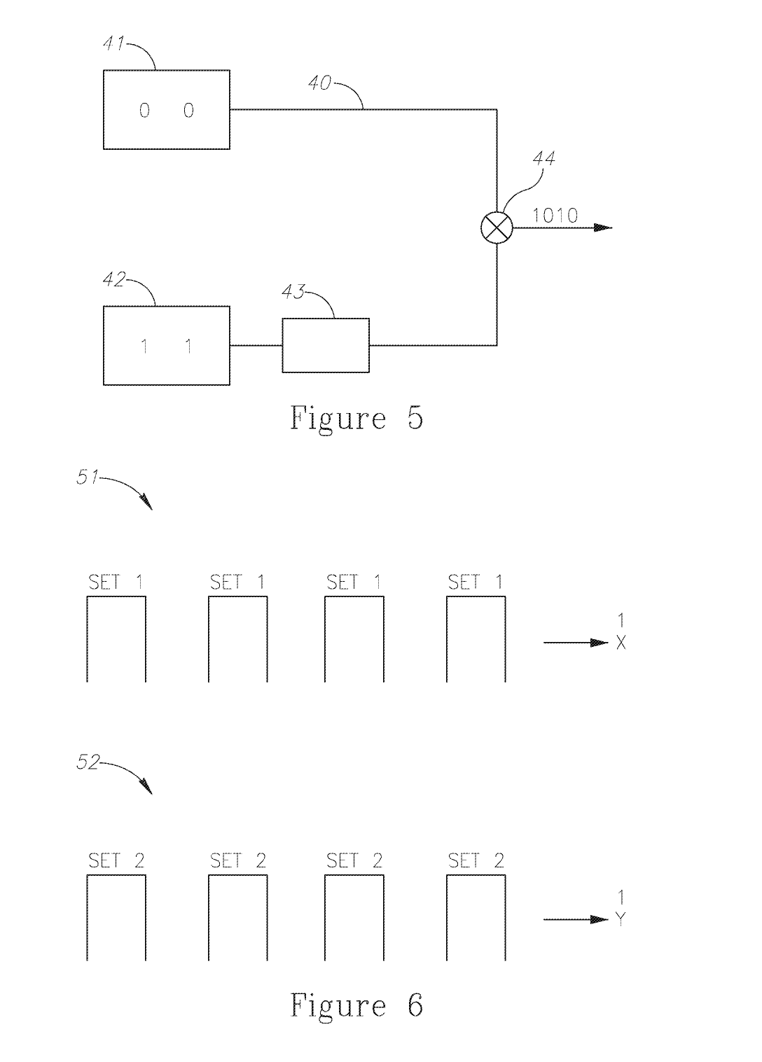

FIG. 3 is a schematic illustration of successive signals modulated by different modulation types or have different parameters according to embodiments of the present invention;

FIG. 4 is a schematic illustration of overlapping of signals that may be caused by noise;

FIG. 5 is a schematic illustration of an exemplary transmitter for high-rate data transmission according to embodiments of the present invention;

FIG. 6 is a schematic illustration of data transmission by double polarization according to embodiments of the present invention;

FIG. 7 is a schematic illustration of data transmission of different sets of symbols by, for example, different frequency channels according to embodiments of the present invention;

FIGS. 8A and 8B are schematic illustrations of transmission of overlapping signals and carrying different sets of symbols, respectively, to enable differentiation between the signals according to exemplary embodiments of the present invention; and

FIG. 9 is an exemplary system for DQPSK double-rate transmission according to embodiments of the present invention.

FIG. 10A is a schematic representation of communication system consists of multiply different data wireless channels added together in the transmission unit and transmitted as one channel according to embodiments of the present invention.

FIG. 10B is a schematic representation of communication system of multiply different data channels that are transmitted as separate channel and received and detected in the reception unit according to embodiments of the present invention.

FIG. 11 is a schematic representation of communication system for transmittance and/or detection of overlapping signals according to embodiments of the present invention.

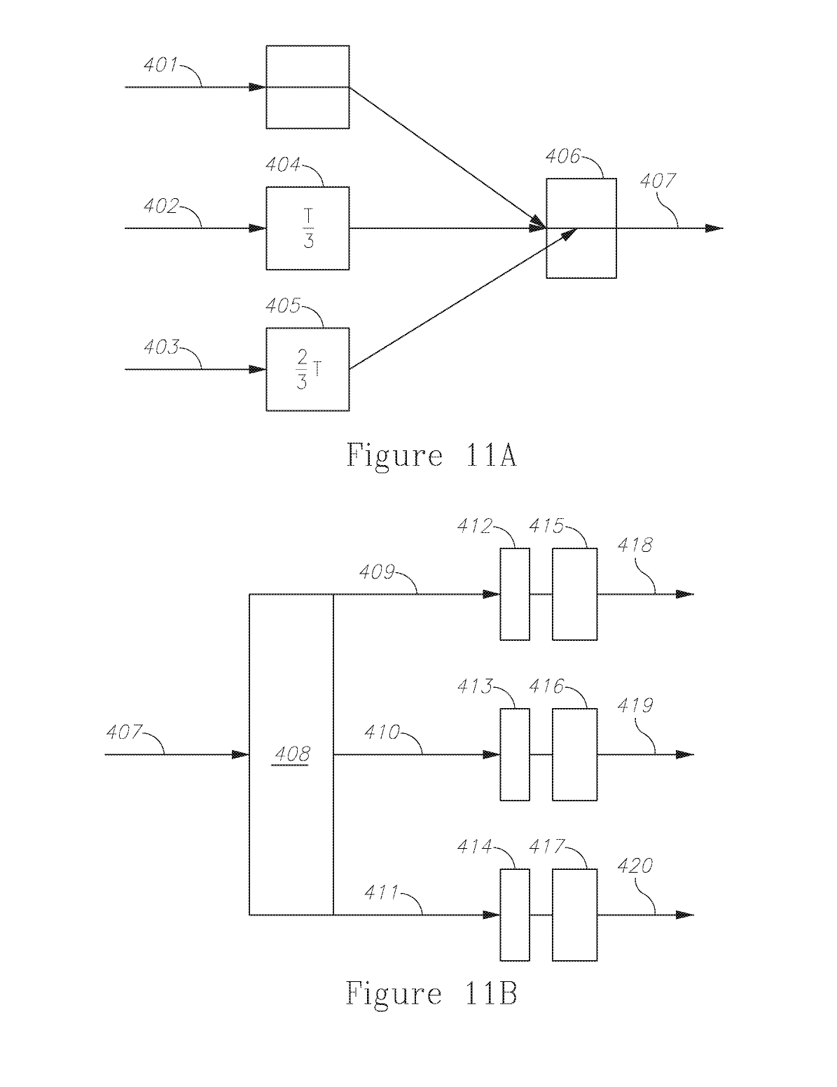

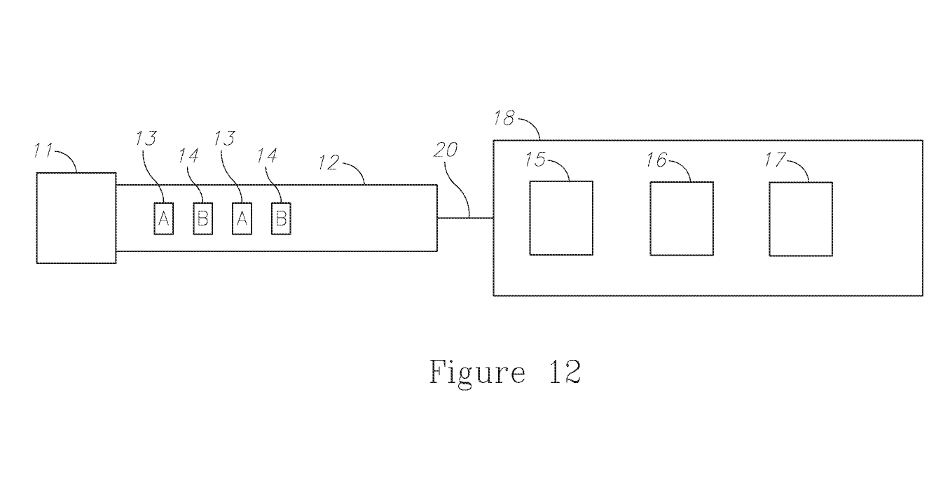

FIG. 12 is a schematic representation of optical data communication system according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details.

The present invention provides a method and apparatus for a new data transmission for increasing bit rate and reducing errors in an wire and wireless transmission systems such as: RF, Cellular, Wi Fi, optical communication, cupper wires, Satellite, computers cluster or Sonar.

The present invention provides a transmission method and apparatus for reducing errors from inter symbol interference Chromatic dispersion, reflection and scattering.

The present invention provides a transmission method and apparatus for reducing signals errors of Polarization Mode Dispersion in optical communication systems. The present invention provides a transmission method and apparatus for reducing reading errors caused by symbols overlap.

The present invention also provides a transmission method and apparatus for reducing signals errors caused by interference of two or more transmissions.

The present invention provides a transmission method and apparatus for increasing bit rate and data capacity transmittance by transmitting and reading overlap signals.

According to an aspect of the present invention, there is a system including a transmitter of data signals, a propagation media and a receiver. The transmitter unit transmits data signals wherein successive signals have different modulations. By switching between two or more different modulation types signals errors caused by delayed signal or part of a signal or spread signals that enter the time frame of an adjacent data signal are reduced. The receiver in this invention identify the modulation type of the data signal and indicates if the signal belongs to a certain time frame or if it is a noise signal that enter this time frame because of signal spread or delay. By this method of two or more different modulation types in successive signals, the time length that is free of errors from delayed or broadened signals is increasing significantly.

In preferred embodiments of the present invention, the transmitter includes data signal generator that can alternate between different modulations such as different phase or frequency etc. In another preferred embodiment of the present invention, the transmitter has two or more data signal generators, each generate a different type of modulation. Additionally there are delay segments that control the transmittance time of the signal in a way that each signal will follow a signal from a different signal generator with a different modulation type.

In a preferred embodiment of the present invention, the propagation media can be a wave guide and particularly an optical fiber.

In another preferred embodiment of the present invention, the wave guide can be an integrated optics wave guide.

In a preferred embodiment of the present invention, the propagation media can be free space such as wireless or RF transmission.

In a preferred embodiment of the present invention, the propagation media can be liquid such as, for example, water for sonar radiation.

In a preferred embodiment of the present invention, the propagation media can be a wire such as copper wire.

In a preferred embodiment of the present invention, the receiver unit compares the received signals to internal data information or algorithm indicating the type of signal that should be received at each time segment. If the type of the received signal and the type indicated in the internal information in the receiver unit are identical, the received signal is considered as data. If the type of the received signal and the type indicated in the internal information are not identical, the received signal is considered as noise and may be ignored or canceled. This method of the present invention enable a communication system to increase the time length of a delayed or broadened signal by one signal cycle and to ignore noise signals in this time range, leading to substantially less error probability or to transmitting data signals at a higher rate.

The present invention also provides a transmission method and apparatus for reducing signal errors caused by interference of two or more transmissions.

According to an aspect of the present invention, there is a system including a transmitter of data signals, a propagation media and a receiver. The system may include a feedback unit for identifying a signal transmitted from the transmitter that have a correct signal type and that has been received at a given time by the receiver.

One aspect of the present invention is to provide a system able to send many data transmissions to the same antenna by using the same spectrum.

Embodiments of the present invention provide solution to increase the data bit rate and to reduce reading errors in a wireless data transmission such as a cellular system transmission, satellite transmission, Wi-Fi, Telephony and GPS or wired data transmissions such as optical communication transmissions or copper wire transmissions and computer nets data transmissions.

In the following detailed description, numerous specific details are set forth in order to provide a thorough understanding of the invention. However, it will be understood by those skilled in the art that the present invention may be practiced without these specific details and may be practiced in other embodiments that may depart from these specific details.

Moreover, it is apparent that the described functions may be implemented using software functioning in conjunction with a programmed microprocessor, a general purpose computer or general or specific integrated circuits. The invention may also be embodied in a computer program product.

Embodiments of the present invention provide wireless or wired data transmissions, wherein two or more successive data signals are different from each other by different modulation types and/or different information states parameters. This enables the system to identify the different data signals in case there is some overlap between signals. This new method enables to overcome reading errors caused, for example, by overlap symbols or noise. Overlap between data symbols may be caused by several reasons such as, for example, symbols dispersion, reflection or different propagation path lengths.

It will be appreciated that throughout the present description, a “signal” is carrying a data, which may include a data unit (bit) or a several data units (bits).

It will be appreciated that throughout the present description, “set” has the meaning of the group of possible symbols. The terms “signal”, “symbol”, may also be used interchangeably where appropriate. Each symbol is a combination of different information states, each presenting a bit. Thus, in order to construct different sets, different information states are defined for each set for constructing different symbols. The different information states in symbols from different sets can be differentiated by the magnitude of values or changes in phase, frequency, amplitude and more, which represent each information states.

It will be appreciated that throughout the present description, successive or adjacent transmitted data may include two or more signals transmitted one after another.

The definition of modulation method in the present invention includes modulation type or modulation parameters.

Throughout the present description, different types of signals may mean signals that belong to different sets.

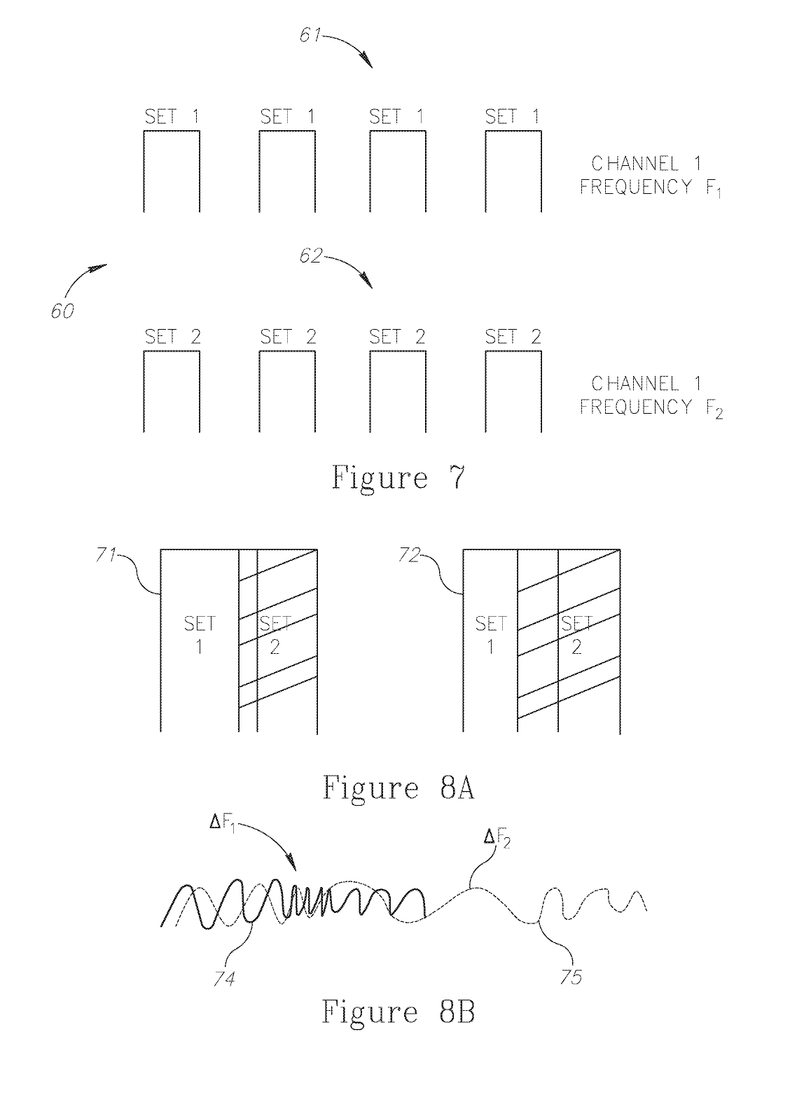

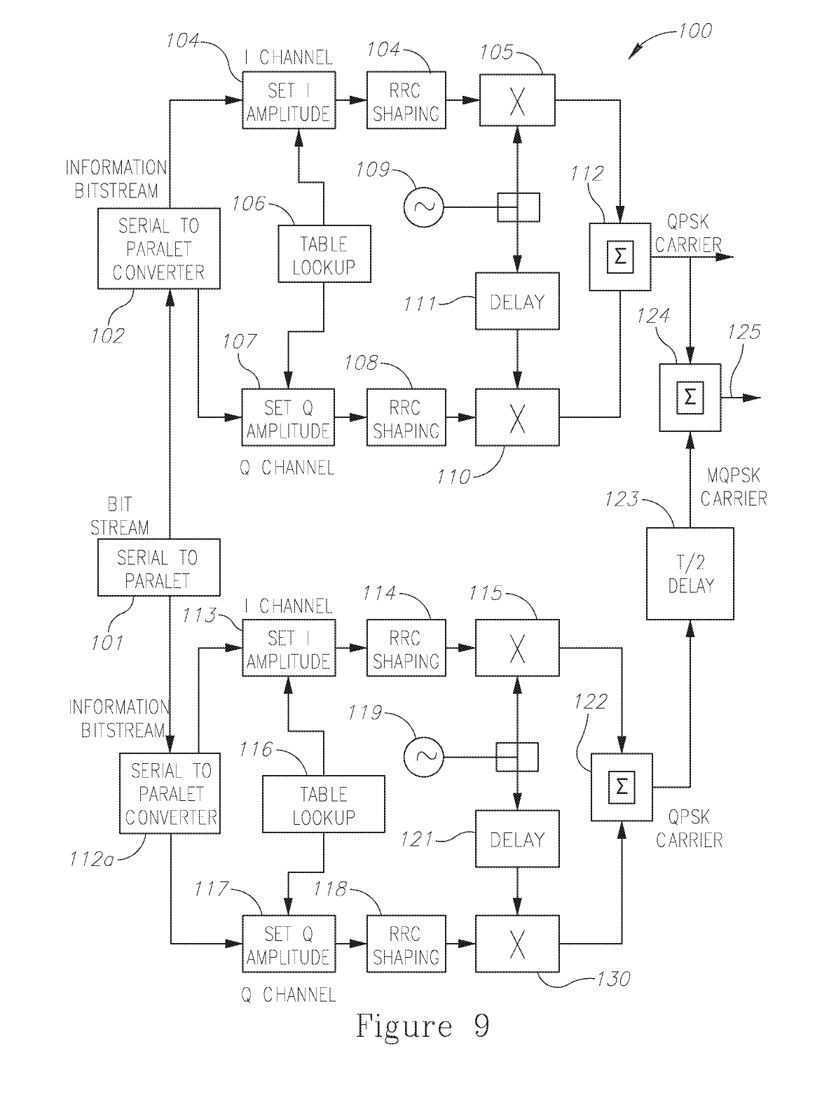

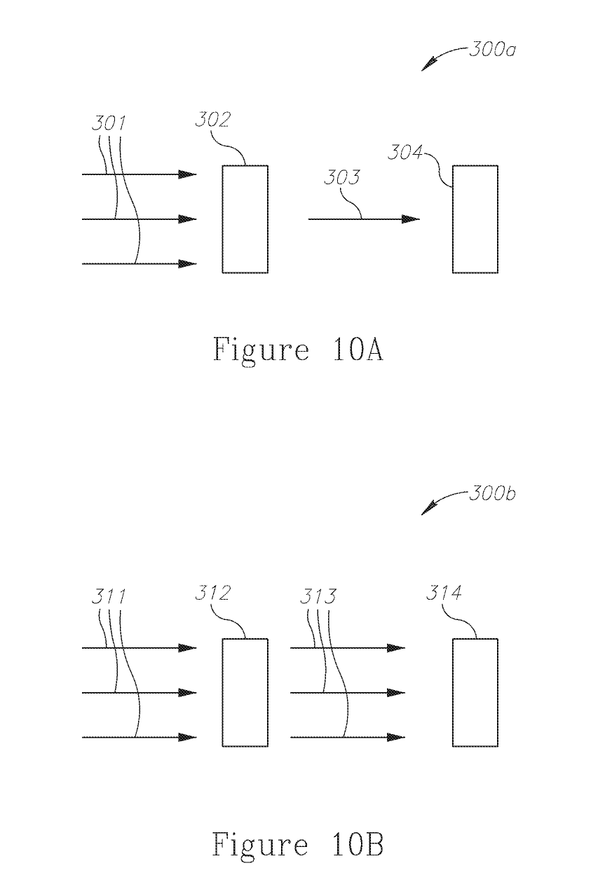

Reference is now made to FIG. 2, which is a schematic illustration of a data communication system 10 for high-rate data transmissions according to embodiments of the present invention. Data communication system 10 includes a data signals transmitter 1, a receiver unit 4 and transmission media 8. Data signals transmitter 1 may transmit for example successive information signals 2 and 3 with different types of transmission, such as different modulation types an and/or different pre-defined sets of symbols. Transmitter 1 may include a data signal generator that may produce alternately said different modulation methods such as different phase or frequency or other modulation methods. Alternatively or additionally, transmitter 1 may include two or more data signal generators, each may generate different type of modulation. System 10 may include a receiver unit 4 and a transmission media 8. Receiver unit 4 may include a data signals receiving unit 5, a comparator 6, and a storage 7 of detected data. Transmission media 8 may include wireless or RF transmission media, optical fibers, integrated optics, wave guides, wires such as copper wires, a liquid such as in sonar radiation and/or any other suitable media.

The operation of data communication system 10 is suggested by FIG. 2. Transmitter 1 may produce a data transmission by generating data signals such as optical signals, RF signals, sonar signals, electric signals or any other type of signals depending on the application. Successive transmitted data signals may be encoded by different modulation types or by a same modulation type with different parameter values representing the data states, to distinguish between successive transmitted data signals. The data signals are intercepted by device 5 in the receiver unit 4 and compared by device 6, which has information on what signal type should be received at each time. This information may arrive to the comparator device 6, for example as synchronization transmission, and/or may be stored in a memory of device 6. If a signal from the data transmission has the same modulation type that supposes to be according to the order of transmission and reception of the signals or in a certain time segment indicated in the synchronization information this data signal is identified as a valid signal. If not, the signal is identified as a noise and ignored. Said noise may be originated from dispersion, mode polarization dispersion, scattering or reflection. The valid signals arrive to device 7, which may be used for several applications such as data storage, signals transmitting to additional optical fiber or wireless transmission. Comparator 6 compares the synchronization information to the received data signal. System 10 may include a feedback unit that may transmit information from the transmitter to the comparator about the timing and types of the valid signals. For example, an additional feedback signals can be added to the data signals by transmitter 1, including information about the location and types of the valid signals. The synchronization information may include internal data information or algorithm indicating the type of signal that should be received at each time segment or the order of appearance of the different symbol sets. If a signal from the data transmission matches the corresponding synchronization information and/or has the proper modulation type as in the corresponding synchronization information, the data signal may be identified as a valid signal. If not, the signal may be identified as noise, for example originating from dispersion, mode polarization dispersion, scattering, reflection or any other reason, and may be ignored. The signals identified as valid arrive to storage 7 which may store the data and/or transmit the data further.

The data signals according to embodiments of the present invention may propagate in free space such as in wireless or RF transmission, optical fibers, integrated optics wave guides, wires such as copper wires, liquid such as in sonar radiation, or any other suitable transmission media 8.

According to embodiments of the present invention, said data transmission system can reduce significantly the reading errors of the data transmission. Embodiments of the invention can increase significantly the data bit rate of the data transmissions too. The data transmission method according to the present invention enables reading and identifying of the initial order of appearance of signals that overlap or interfere with each other by the time they arrived to the receiver because of the inherent difference in successive signals. This enables to transmit signals in a higher rate without concerning about errors caused by signals overlaps and inter symbol interference. In addition, this enables to reduce time intervals in the transmission intended to avoid signals overlap. Instead, said time interval may be used to transmit data signals thereby increasing the transmission data bit rate. [symbol] overlapping signals may be caused by reflections, different propagation distances, dispersion and more.

Another embodiments of the present invention with reference to FIG. 2, is a free space data communication system such as a cellular system, a satellite communication system, Wi-Fi or a free space optical communication system. System 10 includes a data signals free space transmitter 1 of signals that are switched between two or more different modulation types, wherein successive signals such as signals 2 and 3 have different modulation types. The data communication system 10 further includes a receiver unit that includes an element 5 for receiving free space data signals. A comparator element 6 compares between the received signals and information on the original transmitted signals, to identify which signals are in the original transmitted sequence and which are a result of polarization mode dispersion, chromatics dispersion or scattering. The data of the signals identified as belonging to the originally transmitted sequence are transferred to element 7, where it is stored or transmitted further to other devices.

The operation of a wireless data communication system is suggested by FIG. 2. The transmitter 1 generates free space data signals. The free space signals alternate between different modulations wherein successive signals 2 and 3 have different modulation methods for identifying the signal state. In FIG. 2, two types of modulations serve as an example and there can be more than two different modulation types, wherein successive signals have different modulation types. The transmitted data signals enter the receiver unit. The reception element 5 in the receiver unit 4 can be, for example, an RF antenna. Comparator 6 may compare between the received signals and synchronization information, to identify which signals are valid signals from the originally transmitted sequence and which are a result of inter symbol interference, noise, reflection or any other interferers. In comparator 6, the received signals may be transformed to electronic data, for example by a transformer. Additional feedback signals can be added to system 10 for transmitting information from the transmitter to the comparator about the location of the signal relative to other signals in the transmission and types of the valid signals. The data of the valid signals may be transferred from comparator 6 to unit 7 for storage and/or transmission further to other devices. Embodiments of the present invention may enable many data transmissions to the same antenna using the same spectrum. RF transmissions may be enabled on the same spectrum at neighboring antennas of the cell site, while avoiding potential interferences. Additionally, data capacity may be increased in wired data transmission. In comparator 6, the optical signals may be compared to reference information, wherein the optical signals may be transformed to electronic data or may be compared optically.

A specific non limiting example of system 10 may be a 3-G femtocell transceiver, which includes a transmitter 1 having a carrier frequency of 1920-2170 MHz, Gain control range 60 dB and input common mode voltage 1-1.4 V. The receiver unit 4 has gain control range of 90 db, RF input frequency of 1805-2170 MHz and output common mode voltage of 1.1-1.3 V. The transceiver work with WCDMA method, wherein the modulation is two different sets of QPSK for each two successive signals respectively, according to the present invention.

Another embodiment of the invention is described in reference made to FIG. 3 which is a schematic illustration of signals 21a-21e, wherein successive signals A, B may be modulated by a different modulation type. In this embodiment, modulation types A and B may be different phase-shift modulation (PSK), e.g. each may have a different phase shift for indicating information bit “1”. For example, one signal type may indicate information bit “1” by a phase-shift of 90 degrees a second signal type may indicate information bit “1” by a phase-shift of 180 degrees. Generally, in embodiments of the present invention there may be more then two alternating sets in successive signals. For more than two different alternating sets, different pairs of phase shifts for the two bits states can be specified to each set of two symbols. Application of PSK modulations in the present invention refer to continuous phase modulation (CPM) as well.

In further embodiments of the present invention, modulation types A and B may be different differential phase-shift modulation (DPSK), e.g. each may have a different differential phase shift for indicating information bit 1, which is shifted relative to the phase of the previous signal. For example, in first signal the modulation indicates 1 by 90 degree phase shift relative to previous signal and in the second the modulation indicates 1 by 180 degree phase shift relative to previous signal.

In another embodiment of the invention, each of the modulation types A and B may have a different initial phase, while the phase-shift is the same at both types. For example, A may have a phase offset of 30 degrees and a phase-shift of 90 degrees to indicate information bit “1”, which will result in a total phase of 120 degrees. The symbols in the second set may have a phase offset of 50 degrees and a phase shift of 90 degrees to indicate information bit “1”, which will result in a total phase of 140 degrees. Generally, in embodiments of the present invention any pairs of different initial phases and/or phase shifts may be set. There may be more then two alternating modulation types, for example as long as each of successive signals are modulated by different modulation types, wherein each modulation types will be defined by different values of phase offset and phase sets.

In further embodiments of the present invention, modulation types A and B may be different frequency shift keying (FSK), e.g. each of A and B may have different frequency shift for indicating information bit “1”. For example, one signal type may indicate information bit “1” by a first frequency shift from the carrier frequency and a second signal type may indicate information bit “1” by a second frequency phase shift. There may be more then two alternating modulation types, for example as long as successive signals are modulated by different modulation types. These different frequency shifts can be defined for each different modulation. In further embodiment of the invention symbols containing more than two data segment are modulated by more than one frequency shift, wherein different sets of symbols have different values of frequency shifts.

In some embodiments of the present invention, the different modulation types A and B may include minimum shift keying (MSK), audio frequency shift keying (AFSK), multiple frequency shift-keying (MFSK), continuous phase frequency shift keying (CPFSK), and/or any other suitable method.

In further embodiments of the present invention, modulation types A and B may be different signal polarizations e.g. each of A and B may have different polarization for indicating information bits 0 or 1. For example, one signal type may indicate information bit “0” (or “0” data state) by a 45 degrees polarization and information bit “1” (or “1” data state) by a 90 degrees signal polarization. A second signal type may indicate “0” state by a 135 degrees signal polarization and “1” state by a 180 degrees signal polarization.

In further embodiments of the present invention, each of modulation types A and B may have different polarization change to indicate “0” or “1” information bit. For example, one signal type (for example, A) may indicate state “1” by a 90 degrees polarization change from the polarization of the previous signal. a second modulation type may indicate state “0” by a 135 degrees polarization change from the polarization of the previous signal. In some embodiments, more than different successive sets are possible and different pairs of polarization or polarization change (for “0” and “1” states) can be specified for each modulation type.

In some embodiments, more than two information states are allowed in a symbol and more polarization values or polarization shifts values may be defined for each set.

In further embodiments of the present invention, modulation types A and B may be different Quadrature Phase Shift Keying (QPSK) modulation types, with different phase shifts for indicating the data states for each signal type. For example, one signal type may use phases of 20, 80, 140 and 220 degrees to indicate the four possible states and a second signal type may use phases of 45, 90, 135 and 180 degrees to indicate the four possible states (“00”, “11” “01” and “10”). Generally, in embodiments of the present invention, any sets of four phases may be set. There may be more then two alternating modulation types, for example as long as successive signals are modulated by different modulation types different phases can be specified to each modulation type. In some embodiments of the present invention, different modulation types can be realized in the same manner with minimum shift keying (MSK), offset QPSK (OQPSK), and/or any other suitable method.

Another implementation of said modulation method, illustrated in FIG. 3 comprise alternating signals modulation types A, B of amplitude modulation. Each of the signal modulation types have different amplitude modulation for indicating information signal 0 or 1 for example first signal modulation type indicate zero by 0.2 modulation depth (indicates by how much the modulated variable varies from its ‘original’ level) and signal state 1 by 0.4 modulation depth, second signal modulation type indicate zero state by 0.6 modulation depth and 1 state by 0.9 modulation depth. Another implementation of said modulation method, illustrated in FIG. 5 comprise alternating signals modulation types A, B of differential amplitude modulation where the states 1 or 0 indicated by difference in amplitude relative to the previous signal of same modulation type. Each of the modulation types has different amplitude modulations changes for indicating information signal 0 or 1 or same amplitude modulations for indication 1 or 0 states and may have different initial amplitude for each signal modulation type. For more than two different alternating modulation types different pairs of amplitude modulations can be specified to each modulation type. For signals contains more than one bit more levels of amplitude changes can be defined for each symbols set.

All the data signals with different modulations type described in the present invention can be used as a modulation signal in spread spectrum systems.

Reference is now made to FIG. 4, which is a schematic illustration of overlapping of signals that may be caused by noise. FIG. 4 shows signals 31 and 33 modulated by different modulation types A and B, and a delayed fraction 32 of signal 31 which is modulated by modulation type A. Fraction 32 partially overlaps with signal 33. Causes for overlapping signals may be, for example, a signal broadening, delay caused by polarization mode dispersion, chromatic dispersion, scattering, reflections and/or any other reason. By having especially assigned different modulation types A and B, a receiver may detect fraction 32 correctly as belonging to signal 31 and distinguish between signal 31, including fraction 32, and signal 33 modulated by a different modulation type.

Reference is now made to FIG. 5, which is a schematic illustration of an exemplary transmitter 40 for high-rate data transmission according to embodiments of the present invention. Transmitter 40 may include data signals generators 41 and 42, a time delay unit 43 and output 44. Transmitter 40 may produce and transmit data transmission signals such as optical signals, RF signals, sonar signals or any other suitable type of signal. Generators 41 and 42 may each generate data signals with a different modulation type as described throughout the present description. Time delay element 43 may be positioned after one of the signal generators, for example after signal generator 42. Time delay element may cause a data signal propagating from signal generator 42 towards output 44 to arrive at output 44 after a data signal generated at the same time in signal generators 41. This way, transmitter 40 may transmit by output 44 successive signals that have different modulation types. Additionally, in some embodiments of the present invention, more than two alternating different modulation types may be used, wherein more than two successive transmitted signals may have different modulation types. In such embodiments, an additional parallel signal generator and a corresponding time delay unit may be included in transmitter 40.

It will be appreciated that each of the modulations method that may be implemented in the present invention may be performed by multi channel or multi carrier transmission such as, for example, orthogonal frequency-division multiplexing (OFDM), direct-sequence spread spectrum (DSSS), frequency-hopping spread spectrum (FHSS) or multiplexing transmission, for example wavelength-division multiplexing (WDM), time-division multiplexing (TDM), frequency-division multiplexing (FDM), statistical multiplexing, code-division multiplexing (CDM), alternating polarization, phased multi-antenna array, orthogonal frequency-division multiplexing access (OFDMA), multiple-input multiple-output communications (MIMO), channel access method and/or any other suitable manner.

Another embodiment of the present invention is described in FIG. 6, which is a schematic illustration of data transmission by double polarization according to embodiments of the present invention. Data transmissions 51 and 52 may be transmitted on the same optical or RF carrier, for example by orthogonal polarizations of the data transmissions. Additionally, each polarization may be configured to carry a different set of data symbols. For example, transmissions 51 and 52 may be polarized in directions x and y, respectively, wherein transmission 51 may carry a first set of symbols (wherein each signal in the transmission may carry a symbol from set 1) and transmission 52 may carry a second set of symbols (wherein each signal in the transmission may carry a symbol from set 2).

For example the data transmission is modulated by frequency shift modulation of two data states one and zero. In one polarization the switching state one is described by frequency f1 and switching state zero is described by frequency shift f2. In the second polarization the state 1 is described by frequency f3 and the state zero is described by frequency f4. Where f1, f2, f3, f4 are different frequencies. Another example is different amplitude levels in QAM modulation. For each of the polarizations there is a different set of amplitude levels describing the entire symbol set available in this polarization.

In other embodiments of the present invention, the data transmissions carried by different polarizations may be modulated, for example, by different amplitude levels, for example by QAM modulation. In such cases, each of the transmissions may have a different set of amplitude levels, wherein each of the amplitude levels indicates a different data state, i.e. a different symbol. Therefore, each of the transmissions may carry a different set of symbols. Other possible modulation types for similar embodiments may include FM, QPSK, PSK, AM etc.

In some embodiments, each of the different polarization carriers may be configured to carry data transmissions with a different type of modulation. That is, transmissions carried by a first polarization can be modulated by a first type of modulation such as, for example, FSK modulation, and transmissions carried by a second polarization can be modulated by a second type of modulation such as, for example, OAM modulation. It will be appreciated that a carrier may carry more than two polarizations, and/or the polarizations can be in different angles and/or that at least two of the polarizations may carry different sets of symbols. Additionally or alternatively, in some embodiments, instead of having one frequency carrier for the two or more polarizations, there may be more than one frequency carrier transmitted in parallel. In each carrier may transmit in one or more polarization. A purpose of having different sets of symbols may be for reducing reading errors from inter symbol interference between different polarizations, which may be caused, for example, by polarization mode dispersion. Additionally, it will be appreciated that within each polarization carrier, adjacent signals in a certain data transmission may be configured to include symbols from different pre-determined set, or alternatively, the different sets may be assigned to each adjacent couple of signals or any other suitable configuration.

Another embodiment is data transmission for GPS—global poisoning system. For getting more accurate position measurements and for avoiding inter symbol interference in satellite transmission caused for example from different propagation length or dispersion, especially when the car is moving. The GPS transmission in this embodiment use different sets for adjacent signals as described in other embodiments of the invention. Another option is transmitting signals on the same frequency channel with different sets that are not necessarily adjacent. The different sets in the GPS transmission are able to transmit data at higher rates while avoiding reading errors from inter symbol interference. Higher data rate results in higher resolution in distance and location measurement. This embodiment is also referred to other satellite transmissions not only to GPS.

Another embodiment of the present invention is a transmission of different sets of symbols in different consecutives in frequency sub channels of multiple frequency data transmission. For avoiding reading errors from inter channel interference or frequency overlap signals caused, for example, by Doppler shift. For example, in cellular systems, satellite systems, WiFi, optical systems or any other suitable types of transmission. FIG. 7, which is a schematic illustration of two consecutive in frequency sub channels of multi frequency data transmission, for example OFDM. Each of channels 61 and 62 has a different set of symbols as described in the present invention. For example, one channel is modulated by QPSK and the other channel is modulates by QAM. Multiple frequency transmission 60 may include, for example, two frequency channels 61 and 62 that may be configured to transmit different symbols sets 1 and 2, respectively.

In this configuration, an inter channel interference may be detected and filtered in the receiver, because there is a difference between the sets of symbols transmitted by each channel.

The only symbols that would be detected as true signal, would the symbols from the set in the appropriate channel. Wireless transmission of this embodiment can reduce or cancel the guards channel bandwidth and/or the number of guarding channels between the transmission channels in multi frequency transmission. The embodiment also refers to more than two channels consecutive in frequency, wherein each of the channels has a different type of signals modulation. An advantage of this embodiment, for example, is enabled transmission at higher data bit rate in the same transmission bandwidth or transmission at the same data bit rate in a smaller transmission bandwidth. By reducing the guard interval bandwidth in this channel, the bandwidth may be used more efficiently, transmitting data signals instead of guards channels. Another advantage is a reduce the reading errors in multi frequency transmission for example in cellular systems. This invention can decrease the interferes in the cellular communication when driving, which makes the cellular transmission more vulnerable to reading errors from Doppler shift or reflections. It will be understood that several different sets may be transmitted in consecutive signals in one or more of the frequency channels for avoiding reading errors caused by inter symbol interference from symbols on the same channel as described in previous embodiments.

Another embodiment of the present invention is transmission of two or more consecutive symbols, each belong to different sets of modulations types or values according to the description and embodiments of the present invention, wherein said symbols have overlap in space and time. The overlap symbols can be detected and identified because each of them is defined by different sets. An advantage of this embodiment of the present invention is significant increase in the data bit rate of the data transmission. Reference is made to FIGS. 8A and 8B, which are schematic illustrations of transmission of overlapping signals 71 and 72 carrying different symbols belonging to sets 1 and 2, respectively, to enable differentiation between the signals. The overlapping signals are transmitted from the same source or on the same channel. For example in FIG. 8B, two symbols 74 and 75, each belonging to a different pre-defined set 1 or 2, may be modulated by frequency modulation. The different symbols may be expressed by different frequency shift modulation delta f1 and delta f2, respectively, and may be identified according to the frequency modulation.

Another embodiment of the present invention is transmission of two or more consecutive symbols, each belong to a different set o modulation type or value according to the description and embodiments of the present invention, wherein said symbols have overlap in frequency domain as well as in time and space domains.

For example, the symbols may belong to two consecutive sub-channels in multi-frequency transmission. The overlapping symbols can be detected and identified because each of them is defined by a different set. An advantage of this embodiment of the present invention is a significant increase in the data bit rate of the data transmission, for example by reducing or cancelling completely the guards channels in the transmission.

Another embodiment of the present invention is a method to identify between two or more consecutive symbols by assigning a different set to each of the consecutives signals. The different sets are modulated by differential phase shift keying, wherein the difference between the sets is realized by phase shifts relative to the previous symbol and by the values of the phase shifts for each of information states, wherein in each set said values are different. For example, for a transmission where two consecutive symbols belong to sets 1 and 2, respectively, set 1 of DQPSK is defined by phase shifts of 20, 80, 120, 200 degrees and set 2 is defined by phase shifts of 45, 150, 250, and 320 degrees where the differential phase shift is determined from the phase of the previous signal, which belong to the other set. For example, a symbol with a 80 degrees phase will be shifted in 120 degrees to transmit the two signals symbol 01. The 200 degree phase shifted symbol would be phase shifted by 45 degrees to result in a phase of 245 degrees, defining state 00 in set 2.

Reference is now made to FIG. 10, which is an exemplary system 100 for DQPSK double-rate transmission according to embodiments of the present invention. System 100 may add together two communication transmission systems, thereby doubling the data rate transmission. Said two communication transmission may be transmitted by different sets thereby this exemplary system can demonstrate transmission wherein two consecutive symbols belong to two different sets.

Referring to FIG. 9, it describes an example of double rate DQPSK modulation transmission system. The optical communication system 100 consist of a bit stream which split into two parallel channels by element 101 first channel spilt to two parallel channels each have a duty cycle smaller than half. First channel is split be element 102, to channels, one of I amplitude 103 and the second channel of the Q amplitude 107 where 106 is the table lookup. From both I, Q sets the transmission goes to RRC shaping 104, 108 respectively. I is multiply by cos (2*pi*fcT) 105 and Q multiply by sin (2*pi*fcT) 110 both sets are summed in 112. A similar structure is for the second transmission channel information beat stream, which modulated to signals transmission by elements 102a and 113-122 and 130. A delay of half the time cycle 123 given to the second channel thereby when adding together the two data cannels 124 adjacent signals in the transmission MQPSK carrier transmission 125 belongs to different channels, one to the first channel and the next to the second channel. A private case of this system is a transmission, wherein each of the two channels is modulated by a different set, wherein the two channels are added together, it results in a data transmission modulation according to the present invention, wherein adjacent symbols are defined by different sets. Another case of this system is a transmission wherein each of the two channels is modulated in a different polarization for realizing a dual polarization data transmission. It is understood that this system can be extended to a system with more than two parts of data channels transmission added together, resulting in a data transmission in three times or more higher rate, wherein the delay line 123 is changed accordingly, for example three channels system would have two delay lines of t/2 and t.

According to other embodiments, overlap between signals may be achieved by having delay times by delay unit 123 that may be smaller. This may increase the transmission data rate. For example, MQPSK transmittance by overlap signals is achieved by taking the delay time 123 between the two QPSK carriers to be smaller than the time length of a single, resulting in an overlap of successive signals in the MQPSK carrier transmission 125. This embodiment has an advantage of increasing the transmission data bit rate.

Another embodiment of the present inventions is a method to transmit different successive signals by an additional modulation added to a known data transmission, which can be transmitted by any kind of modulation. Said additional modulation is switched between two or more states and is added to successive symbols of the initial data, thereby give difference to each successive state. The number of different successive states is as the number of different modulation states of the additional modulation signals.

Another embodiment of the present invention is a multi channel transmission, where the channels are in similar frequency and different from each other by the different sets the signals in each channel are transmitted by. With reference to FIG. 10A, which is a schematic illustration of a communication system, which is a wireless or wired communication system. System 300a includes several separate data channels 301 in the transmission unit that are transmitted as a one combined transmission, where the channels may have the same carrier frequency. Each of the data channels may have different set or sets of symbols compared to the other data, wherein the different set of symbols is defined in other paragraphs of this application. For example, different sets can be made by different modulations methods. The data channels 301 are added together by an adding part 302 and transmitted as one channel 303. The transmission can be, for example, in RF for a wireless system or an optical transmission inside a fiber optics in a wire system. The transmission is received in the receiver unit 304 that includes a single antenna or multiply antennas for a wireless system or a detector or multiple detectors for a wired system. The receiver unit 304 also comprises a signal processing unit, which can separate the data to the initial channels by identifying the differences in modulations or symbols sets parameters in adjacent signals in the transmission and sorting them to the original data channels. An advantage of this embodiment is an increase in the data bit rate of the transmission while avoiding reading errors and enabling the receiver unit to indentify each of the original channel and read it's data.

Another embodiment of the present invention with reference to FIG. 10A, is a communication system described in the previous embodiment wherein the receiver unit 304 includes several different receivers and demodulators for each of the different modulations methods in the transmittance channel 303. For example each system may use appropriate matched filters or passed locked loop to demodulate each of the initial data channels from the combined transmission. The signals in transmission 303 are received by each of the demodulators in parallel or serial way, by splitting the signal to several signals without losing the data information on the initial signal. Each of the demodulators gets the data information from the modulation or frequency it designed to demodulate. The system may have an option to know the order of appearance of each signals modulation method. The advantage of this embodiment of the present invention is that a data transmitted by a wide bandwidth is demodulated by several narrower bandwidth demodulators. In this embodiment, the transmitted data channel may comprise sub-channels of different frequencies. Another embodiment of the present invention is described with reference to FIG. 10B, which is a communication system, which is a wireless, or a wire communication systems, for implementing a method to transmit data and a method to receive data. The communication system 300b comprises several separate data channels 311 in the transmission unit. Said data channels can be in the same frequency, wherein each of the data channels have different sets of symbols and/or modulation types for transmitting the data, as defined in this application. Each of the data channels may be a multi-frequency channel. The data channels 311 are transmitted as separate channels by a transmission device 312 that includes one or more transmission units 313. The transmission for example can be by RF for a wireless system or an optical transmission inside a fiber optics in a wired system. The transmission device 312 includes one or more transmission sources. The transmission is received in the receiver unit 314 that includes a single antenna or multiple antennas for a wireless system, or a detector or multiple detectors for a wired system. The receiver unit 314 also comprises a processing unit, which can separate the data to the initial channels by identifying the differences in the data symbols and sorting the symbols. The advantage of this method is that several separate data transmissions can multiply the data bit rate compared to one data channel but the total bandwidth doesn't have to be much larger than the bandwidth of one channel (depending on the bandwidth of each channel), because the separate channels are not added together in frequency. In addition, the receiver doesn't have to have a bandwidth much larger than the bandwidth of one transmitted channel since the demodulation is designed individually for each of the transmitted channels separately.

Another embodiment of the present invention with reference to FIG. 10B is a communication system described in the previous embodiment, wherein the receiver unit 314 includes several different receivers and demodulators for each of the different modulations methods in the transmittance channels 313. Said receiver or demodulators can be realized by/with software. The signals in transmissions 313 are received in each of the demodulators in parallel or sequentially. Each of the demodulators modulates the data in the method it is designed to demodulate. The transmission which arrives to the modulator can be the full transmission. In other case, the transmission arrive to preferred demodulator can be partial transmission after filtering by other units in the receiver unit 314. The system may have the option to identify the order of appearance of each signals modulation method.

Reference is now made to FIG. 11A, which is an exemplary schematic illustration of a reception part 400a of a communication system for transmittance and/or detection of overlapping signals according to embodiments of the present invention. The signals may be sent with overlap in order to increase the data bit-rate. Reception part 400a may include data channels 401, 402 and 403, which may be configured to transmit different symbol sets and/or modulation types. Each of data channels 402 and 403 may include a delay unit 404 and 405, respectively, which may delay the transmission by a third cycle time and a two thirds cycle time of a signal, respectively. Reception part 400a may include an adder 406 which may add the three data channels 401, 402 and 403 together, thus, for example, creating a single transmission 407 with the signals coming from channels 401, 402 and 403 at least partially overlapping.

Reference is now made to FIG. 11B, which is an exemplary schematic illustration of a detection part 400b of a communication system for transmittance and/or detection of overlapping signals according to embodiments of the present invention. Detection part 400b may include splitter element 408 that may split the unified data from channel 407, for example to three data transmissions 409, 410 and 411, each may include the same data. Each of the transmissions 409, 410 and 411 may go through a different filter 412, 413 or 414, respectively, which may filter the signals that match the modulation method of one of the initial data channels 401, 402 and 403, respectively. Then, each of the filtered transmissions may go through a demodulator 415, 416 or 417, respectively, which may demodulate the data according to the respective modulation method. Each of the resulting data channels 418, 419 and 420 may have identical data to one of the three initial data channels 401, 402 and 403, respectively.

Another embodiment of the present invention with reference to FIG. 12 of optical data communication system 20 which includes a data signals transmitter 11, an optical fiber 12, wherein successive transmitted signals 13, 14 have different modulation types each for indicating the signal states, a receiver unit 18 comprise a reception element 15, a comparator element 16 and a validation information signals element 17.

The operation of data communication system 20 heuristically suggested by FIG. 12. The transmitter 11 generate optical data signals. The optical data signals alternate between different modulations wherein adjacent optical signals 13, 14 have different modulations for identifying the signal state. In FIG. 4 the two types of modulation served as an example and there can be more than two different modulation types. From the optical fiber the data signals enter the receiver unit. The reception element 15, in the receiver unit 18, can be for example, a len and an optical wave guide, the optical signals are compared to a reference information in the comparator element 16 the optical signals could be transformed to electronic data or could be compared optically An additional feedback unit can be added to system 20 for transmitting information from the transmitter to the comparator about the location and types of the valid signals. After passing the comparator 16, the valid signals enter element 17 wherein the valid signals information can be stored or can be transmitted to other devices such as optical wave guide, fiber optics for example

While certain features of the invention have been illustrated and described herein, many modifications, substitutions, changes, and equivalents will now occur to those of ordinary skill in the art. It is, therefore, to be understood that the appended claims are intended to cover all such modifications and changes as included within the true spirit of the invention.

1-48. (canceled)

49. A system comprising:
a data signals transmitter having a data signal generator configured to produce a data transmission by generating two or more successive transmitted signals having different types of signals; and
a receiver configured to receive the transmitted signals and to identify the signals according to the different types of signals,
wherein the different types of signals are transmitted on a specified order according to which both the transmitter and the receiver knows about.

50. The system of claim 49, wherein said different types of signals comprises different modulation types, and said receiver is to receive generated data signals and to demodulate the signals according to the corresponding different modulation types.

51. The system of claim 49, wherein each of said types of signals is modulated by at least one of a list comprising phase modulation, phase-shift keying modulation, continuous phase modulation, differential Phase shift keying, frequency shift keying, polarization modulation, differential polarization, quadrature phase shift keying, amplitude modulation, QAM, amplitude modulation and a pre-determined set of symbols.

52. The system of claim 49, wherein said transmitter further comprising:
at least two data signals generators, each to generate data signals with a different type of signals; and
at least one delay unit to delay signals generated by a corresponding data signals generator, to provide by said system successive signals of different types.

53. The system of claim 49, wherein said transmitter is to generate successive signals with overlap in time and space, to increase the data bit rate of the transmission.

54. The system of claim 49, wherein successive signals are modulated by the same modulation with different modulations values in each of said signals.

55. The system of claim 49, wherein said transmitter comprises an addition unit to add data from multiple data channels and to transmit them as one channel. Wherein successive channels have different set of symbols.

56. A system comprising:
a data signals transmitter having a data signal generator configured to produce multi frequency transmission wherein adjacent frequency sub channels transmits different sets of data symbols.

57. The system of claim 56, wherein adjacent channels have partial or full overlap in frequency, to increase the data bit rate of the transmission.

58. The system of claim 49, comprising several separate data channels, each transmitting a different set of symbols.

59. A method comprising:
producing a data transmission by generating two or more successive transmitted signals having different types of signals; and
receiving the transmitted signals and identifying the signals according to the different types of signals,
wherein the transmission of different types of signals are based on a specified order according to which both the producing and the receiving knows about.

60. The method of claim 59, wherein said different types of signals comprises at least one of different modulation types and different pre-defined sets of symbols.

61. The method of claim 59, wherein said different types of signals comprises different modulation types, and said receiver is to receive generated data signals and to demodulate the signals according to the corresponding different modulation types.

62. The method of claim 59, comprising generating data signals with a different type of signals and delaying by a delay unit signals generated by a corresponding data signals generator, to provide by said system successive signals of different types.

63. The method of claim 59, comprising producing multiple of said data transmissions, wherein each channel transmits different sets of data symbols.

64. The method of claim 59, comprising multiple channels transmission transmitted at the same time from the same source.

65. The system of claim 56 comprises multiple frequency carriers for said data channels\. Transmitted together from the same output element.

66. The method of claim 59, comprising generating successive signals with overlap in time and space, to increase the data bit rate of the transmission.

67. The method of claim 59, wherein successive signals are modulated by the same modulation with different modulations values in each of said signals.

68. The data transmissions describe in claims 1 wherein said transmissions are inserted in spread spectrum transmissions.
